(19) United States
(12) Patent Application Publication
(10) Pub. No.: US 2025/0328795 A1
(43) Pub. Date: Oct. 23, 2025

(54) REUSABLE READOUT ERROR CALIBRATION AND MITIGATION

(71) Applicant: International Business Machines Corporation, Armonk, NY (US)

(72) Inventors: Paul Nation, Yorktown Heights, NY (US); Roland de Putter, New York, NY (US); Hwajung Kang, Yorktown Heights, NY (US)

(21) Appl. No.: 18/442,054

(22) Filed: Feb. 14, 2024

(51) Int. Cl. G06N 10/40; G06N 10/60; G06N 10/70

(52) U.S. Cl. CPC G06N 10/40; G06N 10/60; G06N 10/70

(57) ABSTRACT

Qubit readout for a plurality of device qubits on a given quantum computer is calibrated using deterministic bit patterns to generate calibration data. Optionally, the calibration data is stored in a database for use in one or more quantum processing tasks on the given quantum computer. A given algorithm is run on the given quantum computer to generate qubit readout data. A readout mitigation is performed to generate revised qubit readout data based on the qubit readout data, the performance of the readout mitigation including issuing, to a calibration routine, a set of labels identifying qubits used in the running of the given algorithm. Correction information is obtained, from the calibration routine, based on the (optionally, stored) calibration data. The readout mitigation is performed using the correction information.

### BACKGROUND

The present invention relates generally to the electrical, electronic and computer arts and, more particularly, to quantum computers and computer-aided software and hardware design and development.

In quantum processing, the readout of qubit data is typically the largest single-operation source of error on quantum computing platforms, such as superconducting architectures. Performing readout error mitigation is a pertinent step to yield high-fidelity results on near-term quantum computers. Efficient readout error mitigation methods, such as a matrix-free measurement mitigation method (a general-purpose mitigation procedure based on the A-matrix (known in the art as the confusion matrix)) and a model-free readout-error mitigation method (which provides for the correction of expectation values based on aggregate noise distributions from twirling) make such computations scalable. At present, however, users must periodically re-run the calibration step for the readout mitigation; that is, the measurement noise must be relearned each time it is needed. The periodicity of conventional calibration techniques is typically determined on a per-device basis. This can consume substantial computing resources and, when measurement errors are stable over time, is an unnecessary task.

### BRIEF SUMMARY

Principles of the invention provide systems and techniques for reusable readout error calibration and mitigation. In one aspect, an exemplary method includes the operations of calibrating qubit readout for a plurality of device qubits on a given quantum computer using deterministic bit patterns to generate calibration data; running a given algorithm on the given quantum computer to generate qubit readout data; performing a readout mitigation to generate revised qubit readout data based on the qubit readout data, the performance of the readout mitigation including issuing, to a calibration routine, a set of labels identifying qubits used in the running of the given algorithm; and obtaining, from the calibration routine, correction information based on the calibration data, wherein the readout mitigation is performed using the correction information.

In one aspect, a computer program product comprises one or more tangible computer-readable storage media and program instructions stored on at least one of the one or more tangible computer-readable storage media, the program instructions executable by a processor, the program instructions comprising calibrating qubit readout for a plurality of device qubits on a given quantum computer using deterministic bit patterns to generate calibration data; running a given algorithm on the given quantum computer to generate qubit readout data; performing a readout mitigation to generate revised qubit readout data based on the qubit readout data, the performance of the readout mitigation including issuing, to a calibration routine, a set of labels identifying qubits used in the running of the given algorithm; and obtaining, from the calibration routine, correction information based on the calibration data, wherein the readout mitigation is performed using the correction information.

In one aspect, an apparatus comprises a memory and at least one processor, coupled to the memory, and operative to perform operations comprising calibrating qubit readout for a plurality of device qubits on a given quantum computer using deterministic bit patterns to generate calibration data; running a given algorithm on the given quantum computer to generate qubit readout data; performing a readout mitigation to generate revised qubit readout data based on the qubit readout data, the performance of the readout mitigation including issuing, to a calibration routine, a set of labels identifying qubits used in the running of the given algorithm; and obtaining, from the calibration routine, correction information based on the calibration data, wherein the readout mitigation is performed using the correction information.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects, as will be discussed further below. Features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 shows sample bit-strings for probing all independent and pairwise correlated errors over select numbers of qubits, in accordance with example embodiments;

FIG. 2 illustrates the slow convergence of random bit-string sampling to a complete A-matrix solution on a conventional simulator, in accordance with an example embodiment;

FIG. 3 is an example workflow for generating, storing and reusing calibration data, in accordance with an example embodiment;

FIG. 4 is an example workflow for storing and reusing calibration data, in accordance with an example embodiment;

FIG. 5 is a flowchart for an example method for storing and reusing calibration data, in accordance with an example embodiment; and

FIG. 6 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Given the discussion herein (reference characters refer to the drawings discussed below), it will be appreciated that, in general terms, an exemplary method, according to an aspect of the invention, includes the operations of calibrating qubit readout for a plurality of device qubits on a given quantum computer using deterministic bit patterns to generate calibration data (operation 504); optionally, storing the calibration data in a database for use in one or more quantum processing tasks on the given quantum computer (operation 508); running a given algorithm on the given quantum computer to generate qubit readout data (operation 512); performing a readout mitigation to generate revised qubit readout data based on the qubit readout data, the performance of the readout mitigation including issuing, to a calibration routine, a set of labels identifying qubits used in the running of the given algorithm; and obtaining, from the calibration routine, correction information based on the (optionally, stored) calibration data, wherein the readout mitigation is performed using the correction information (operation 516). These features include the benefits of improved readout mitigation for quantum processors with deterministic calibration and application regardless of the mitigation method; caching of a singular calibration data source that enables reuse of calibration data, saving device processing time through a reduction in the total amount of time spent calibrating a quantum processor for readout errors; standardizing the readout mitigation process in a deterministic and well-defined fashion; and extension of the lifetime of calibration data for quantum processors (in systems where two-level system (TLS) errors are under control; that is, where fluctuations in qubit parameters, such as the T1 relaxation time, are much longer than the time scale of the corresponding processing) and the savings in processing resources (such as a savings in processing time of approximately 30 seconds per eliminated calibration iteration) of a quantum computer.

In one aspect, a computer program product comprises one or more tangible computer-readable storage media and program instructions stored on at least one of the one or more tangible computer-readable storage media, the program instructions executable by a processor, the program instructions comprising calibrating qubit readout for a plurality of device qubits on a given quantum computer using deterministic bit patterns to generate calibration data (operation 504); optionally, storing the calibration data in a database for use in one or more quantum processing tasks on the given quantum computer (operation 508); running a given algorithm on the given quantum computer to generate qubit readout data (operation 512); performing a readout mitigation to generate revised qubit readout data based on the qubit readout data, the performance of the readout mitigation including issuing, to a calibration routine, a set of labels identifying qubits used in the running of the given algorithm; and obtaining, from the calibration routine, correction information based on the (optionally, stored) calibration data, wherein the readout mitigation is performed using the correction information (operation 516).

In one aspect, an apparatus comprises a memory and at least one processor, coupled to the memory, and operative to perform operations comprising calibrating qubit readout for a plurality of device qubits on a given quantum computer using deterministic bit patterns to generate calibration data (operation 504); optionally, storing the calibration data in a database for use in one or more quantum processing tasks on the given quantum computer (operation 508); running a given algorithm on the given quantum computer to generate qubit readout data (operation 512); performing a readout mitigation to generate revised qubit readout data based on the qubit readout data, the performance of the readout mitigation including issuing, to a calibration routine, a set of labels identifying qubits used in the running of the given algorithm; and obtaining, from the calibration routine, correction information based on the (optionally, stored) calibration data, wherein the readout mitigation is performed using the correction information (operation 516).

In one example embodiment, the readout mitigation comprises a sampling readout mitigation, wherein the correction information comprises a set of matrices and wherein the performing of the readout mitigation further comprises using the set of matrices to solve an algebraic system of equations. These features include the benefit of reusing quantum calibration data for sampling problems.

In one example embodiment, the readout mitigation comprises an expectation value readout mitigation, wherein the correction information comprises a renormalization factor and wherein the performing of the readout mitigation further comprises using the renormalization factor to generate the revised qubit readout data. These features include the benefit of reusing quantum calibration data for variational algorithms.

In one example embodiment, the calibration routine generates the correction information based on the set of labels identifying qubits used in running the given algorithm and an identification of a sampling type of readout mitigation, the correction information comprising a set of matrices generated by marginalizing a data distribution based on the calibration data. These features include the benefit of providing a calibration data processing service for a sampling type readout mitigation method.

In one example embodiment, the marginalized data distribution is renormalized. These features include the benefit of providing a calibration data processing service for a sampling type readout mitigation method.

In one example embodiment, the calibration routine generates the correction information based on the set of labels identifying qubits used in running the given algorithm and an identification of an expectation value type of readout mitigation, the correction information comprising renormalization factor generated by computing expectation values on the qubits identified by the set of labels using Pauli Z observables and the calibration data. These features include the benefit of providing a calibration data processing service for an expectation value type readout mitigation method.

In one example embodiment, the type of readout mitigation performed is based on the use case and wherein the type of readout mitigation performed is an expectation value readout mitigation for variational algorithms. These features include the benefit of providing a reusable calibration data processing service for an expectation value readout mitigation method for variational algorithms.

In one example embodiment, the type of readout mitigation performed is based on the use case and wherein the type of readout mitigation performed is a sampling readout mitigation for sampling problems. These features include the benefit of providing a reusable calibration data processing service for a sampling readout mitigation method.

In one example embodiment, an interface is coupled to the at least one processor and configured to facilitate the running of the given algorithm on the given quantum computer, such as module 115 interfacing to a WAN or other wireless or cabled connection (elements 103, 104 are then also representative of the given quantum computer, interfacing with the at least one processor over the WAN or the like). These features include the benefit of interfacing a classical computer with a quantum computer to run quantum algorithms while efficiently reusing calibration data for readout mitigation. In one example embodiment, the given quantum computer is coupled to the interface and configured to perform the running of the given algorithm. These features include the benefit of interfacing a classical computer with a quantum computer to run quantum algorithms while efficiently reusing calibration data for readout mitigation.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
improved readout mitigation for quantum processors with deterministic calibration and application regardless of the mitigation method;
caching of a singular calibration data source that enables reuse of calibration data, saving device processing time through a reduction in the total amount of time spent calibrating a quantum processor for readout errors;
standardizing the readout mitigation process in a deterministic and well-defined fashion; and
extension of the lifetime of calibration data for quantum processors (in systems where two-level system (TLS) errors are under control; that is, where fluctuations in qubit parameters, such as the T1 relaxation time, are much longer than the time scale of the corresponding quantum processing) and the savings in processing resources (such as a savings in processing time of approximately 30 seconds per eliminated calibration iteration) of a quantum computer.

Generally, a singular method for performing calibration and readout error mitigation on quantum processors is disclosed. The disclosed calibration method is suitable for use with both sampling readout mitigation methods (matrix-free measurement mitigation methods) and expectation value readout mitigation methods (model-free readout-error mitigation methods).

In quantum processors, crosstalk, drift and the like can adversely impact the desired effect of two-qubit gates. Crosstalk during readout can arise from the underlying qubit-qubit coupling, and spectral overlap of readout resonators with stray couplings or multiplexing. Calibration attempts to identify parameters that more closely characterize the actual effect exhibited by two-qubit gates. Error mitigation can then compensate for at least some of the errors induced by the crosstalk, drift and the like. Due to the presence of noise on present-day quantum processors, error mitigation is often applied to reduce the impact of gate and measurement errors on the output of quantum circuit execution. One pertinent idea behind error mitigation is to combine the outcomes of multiple experiments in such a way so as to, on average, cancel the contribution of noise to the quantity of interest. Readout errors in quantum devices, such as those based on superconducting qubits, are often the most error prone operations, and can be well understood in terms of purely classical noise models. Such models describe a noisy n-qubit measurement by a matrix of transition probabilities. It is common to simplify the noise model further by assuming that the noise acts independently on each qubit. Once parameters of the noise model that affect the qubit readout are known through a learning procedure (also known as a calibration procedure), error mitigation proceeds by solving an algebraic system of equations formed from the transition probabilities acting on a vector that represents the noisy measurement outcomes or used to compute a correction factor for computations using qubit observables, such as Pauli operators.

It is noted that the calibration steps for sampling readout mitigation methods and expectation value readout mitigation methods, such as matrix-free measurement mitigation and model-free readout-error mitigation methods, differ, meaning that any attempt to store and reuse calibration data would require multiple runs of a calibration method to collect data for each readout mitigation method. The disclosed singular calibration method can be utilized for both sampling and expectation value readout mitigation methods and is reusable by multiple users, by a single user over multiple jobs and the like. This reuse saves substantial processing resources of the quantum processor.

In one example embodiment, a unified calibration technique is designed for both sampling readout mitigation methods and expectation value-based readout mitigation methods, allowing for a singular source of calibration data. In one example embodiment, the unified calibration technique enables this data to be collected, stored and used later for mitigating an arbitrary input circuit where mitigation on aggregate counts is desired. In one example embodiment, a method enables the collection, storage, and retrieval of calibration data that is valid for any future circuit. As the lifetime of this calibration data improves with improvements to quantum processors, e.g. via improved TLS mitigation methods, the benefits of using this method will continue to grow.

It is noted that the expectation value-based readout mitigation method currently uses random data patterns to perform the calibration. It is recognized, however, that random bit-string twirling in an expectation value readout mitigation method, such as the model-free readout-error mitigation method, can be replaced by deterministic bit-pattern calibration with guarantees on sampling precision of all independent and pairwise correlated errors. In one example embodiment, a deterministic variant of an expectation value readout mitigation method is created by substituting a fixed bit-string for the variable bit-strings to guarantee the calibration quality, yielding a single sampled distribution that, along with some additional data, can be stored and retrieved later for use in multiple rounds of readout mitigation by a collection of users. In one example embodiment, a conventional bit pattern is used to generate the calibration data. This calibration relies on the understanding that readout calibration bit-strings probe various readout error processes, and only independent qubit readout errors, along with pairwise correlated errors are needed to fully characterize all important error processes. Moreover, each error process is sampled to a given, and fixed, precision allowing for proper error analysis. Note that at least one conventional expectation value readout mitigation method does not allow for guarantees about which error channels get sampled, and their sampled precision.

In one example embodiment, an exemplary disclosed technique is integrated with a sampling readout mitigation method (matrix-free measurement mitigation method). This improves the calibration of the quantum processor by reducing the number of circuits from 2N to 2^{floor(log}^{₂}^{(N)+1)} and allows for fixed precison of pairwise correlated errors. (It is noted that the matrix-free measurement mitigation method currently uses other data patterns to perform the calibration.)

FIG. 1 shows sample bit-strings for probing all independent and pairwise correlated errors over select numbers of qubits, in accordance with example embodiments. Example embodiments make use of bit-string patterns that uniformly sample all one-qubit and pair-wise qubit error processes; that is, the data patterns of FIG. 1 provide a uniform way of sampling all of the possible errors that are involved in this process. During calibration, each bit pattern becomes a quantum circuit that is executed on the quantum processor and the calibration data is collected. The calibration data is then processed to be compatible with either the sampling and/or the expectation value based readout mitigation methods. The input of the data patterns is repeated a specified number of times depending on the desired precision, and any desired number of qubits are then sampled. It is noted that the same cost (in terms of execution time) is encountered regardless of the number of qubits. (The fixed cost depends on how precise it is desired for the learning (calibration) data to be.) It is also noted that the skilled artisan will be familiar with applying each bit pattern to implement a quantum circuit that is executed on the quantum processor and to collect the calibration data.

Generally, “learning” or “calibration” is the process of determining the impact of noise on a given set of operations. In one or more embodiments, the operation of interest is qubit readout.

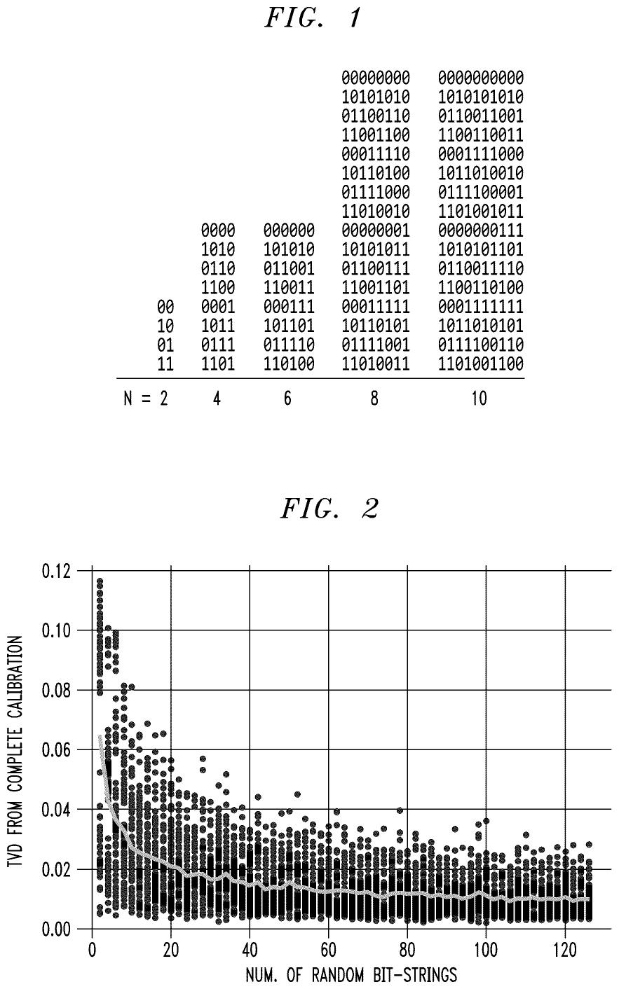

FIG. 2 illustrates the slow convergence of random bit-string sampling to a complete A-matrix solution on a conventional simulator, in accordance with an example embodiment. The x-axis corresponds to the number of random bit strings and the y-axis corresponds to the total variational distance (TVD) from the complete calibration. Each point represents a unique repeated instance of the random calibration. The deviations are due to the random sampling not correctly capturing the errors, such as TLS errors, in the system. Calibration is, by default, performed over all qubits, with the number of samples set to satisfy a specified precision for measuring each readout error process.

Given a target precision set by a given number of samples N, 2*N samples total are taken over all bit-strings in the calibration set to give the specified precision for individual qubit error rates, and N/2 for the pair-wise correlated error rates. Calibration can be used as is for forming A-matrices for the matrix-free measurement mitigation method, or classically processed with bit-flips and aggregated for the deterministic variant of the model-free readout-error mitigation method (a deterministic variant of an expectation value readout mitigation method).

In one example embodiment, a single calibration using the stated bit-string process is performed over all the qubits on a given device in a manner that guarantees the precision of error processing elements, and allows for future reuse of the calibration data over any subset of qubits. This is because viewing calibration from the point of view of sampling error processes to a given precision, such calibrations are no more expensive than those on a subset of qubits; a readout of a full device can be calibrated to the same precision as a sub-graph using the same number of circuit executions.

This data is then stored in a database for retrieval by a user looking to perform readout error mitigation on the target device. The necessary calibration data that needs to be stored is 1) the results from running each calibration circuit; and 2) a mapping of classical bits to physical qubits on the device. This calibration data can be passed to the end-user as is, or in the form of single-qubit A matrices for performing the matrix-free measurement mitigation method, or returned after post-processing with bit-flips matching the calibration bit-strings and aggregated, if using the deterministic variant of the model-free readout-error mitigation method. Although the data is performed over all qubits of a device, experiments can make use of the data directly via appropriate indexing.

In one example embodiment, the mapping of classical bits to physical qubits on the device describes a one-to-one (bijectional) mapping between bits in a bit-string and the qubits on a quantum device. Usually, the bit in location 0 is mapped to qubit 0, the bit in location 1 is mapped to qubit 1, and so on. However, in one or more embodiments, this mapping can be arbitrary provided that it is always one-to-one. For example, if a device includes non-operational qubits, the non-operational qubits would be skipped over and the qubit numbering in the mapping would be modified; that is, the mapping would not be a straight-forward mapping of the bit in location 0 to qubit 0, the bit in location 1 to qubit 1, and so on.

### Storage to Cloud Database

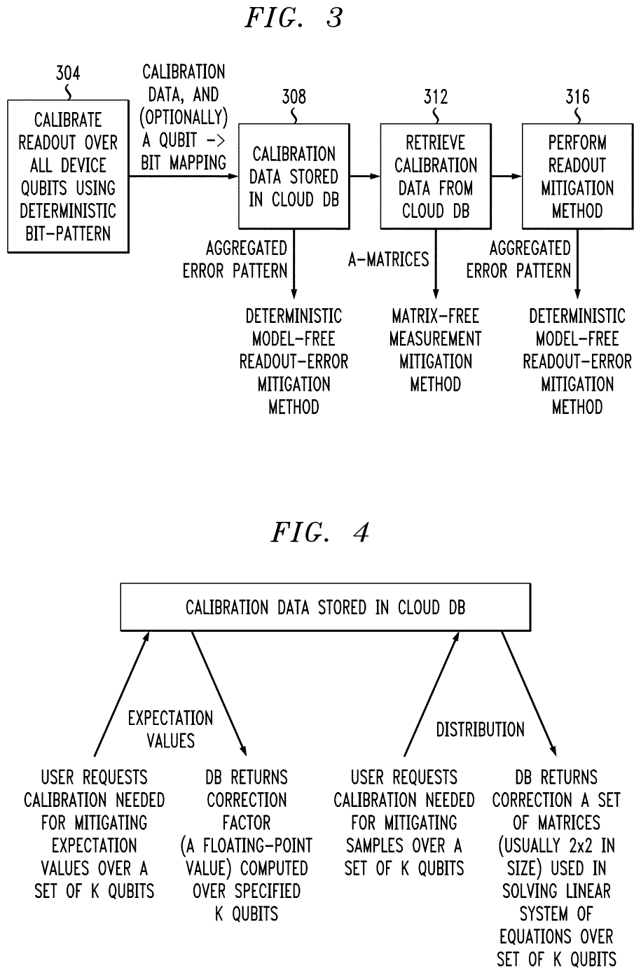

FIG. 3 is an example workflow for generating, storing and reusing calibration data, in accordance with an example embodiment. The qubit readout process is calibrated over all device qubits using deterministic bit patterns (operation 304). In one example embodiment, the learning of the calibration data is performed by generating a quantum circuit according to the specified deterministic bit-patterns (such as the bit-patterns of FIG. 1) where a ‘1’ in the bit-pattern indicates that a quantum circuit should have an X-gate applied to the qubit corresponding to the bit. Thus, each bit-pattern corresponds to a specific quantum circuit that is executed. In one or more embodiments, in order to obtain a calibration/learning of a given precision (here defined with respect to a specific number of samples since precision is bounded above by 1/sqrt(samples)), a total of 2*samples are run, distributed evenly across all the quantum circuits (rounding up if the samples per circuits is not an integer).

In one example embodiment, operation 304 includes the steps of generating calibration bit-patterns over the full number of qubits on the device, constructing quantum circuits on the device with an X-gate applied to the qubit corresponding to the bits having a value of ‘1’, executing the quantum circuits on the quantum device, and returning distributions of bit-strings (the calibration data).

The calibration data (set of distributions) is stored in a database, such as a cloud-based database, for use by a variety of users and quantum computers (operation 308). By calibrating all qubits, all later user scenarios are covered by the same stored calibration data set. (It is noted that the calibration is typically performed continuously. As quantum devices evolve, it is anticipated that calibration will be required to be performed less frequently and will be repeated over some regular time interval determined by device characteristics. Given the teachings herein, the skilled artisan will be able to employ heuristics to determine the periodicity for future quantum devices.)

In one example embodiment, the calibration data is retrieved from the database (operation 312) and a sampling readout mitigation method is performed on qubit readout data obtained from one of the quantum computers (operation 316). In one example embodiment, using simple substitution, the bit-string pattern of FIG. 1 is substituted for a conventional bit-string pattern to guarantee even sampling of the pairwise correlations.

In one example embodiment, the calibration data is retrieved from the database (operation 312) and an expectation value readout mitigation method is performed on qubit readout data obtained from one of the quantum computers (operation 316). In one example embodiment, the step of generating a user specified number of random bit-string patterns in the expectation value readout mitigation method is replaced by a fixed set of bitstring patterns to guarantee precision and enable storage and reuse of the calibration data.

FIG. 4 is an example workflow for storing and reusing calibration data, in accordance with an example embodiment. As described above, the use of the stored calibration data depends on whether the mitigation of expectation values (observables, model-free mitigation) or the distribution of bitstrings (matrix-free mitigation) is selected. In one example embodiment, a user requests calibration data needed for mitigating expectation values over a set of K qubits and the database returns a correction factor (such as a floating-point value) computed over specified K qubits (operation 316).

In one example embodiment, a user requests calibration data needed for mitigating samples over a set of K qubits and the database returns the correction information, such as a set of matrices (usually 2×2 in size) used in solving an algebraic system of equations over a set of K qubits (operation 316).

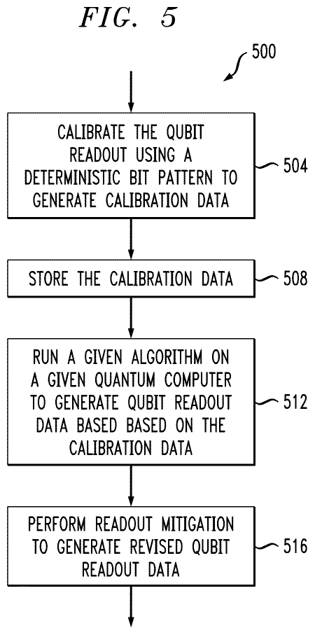

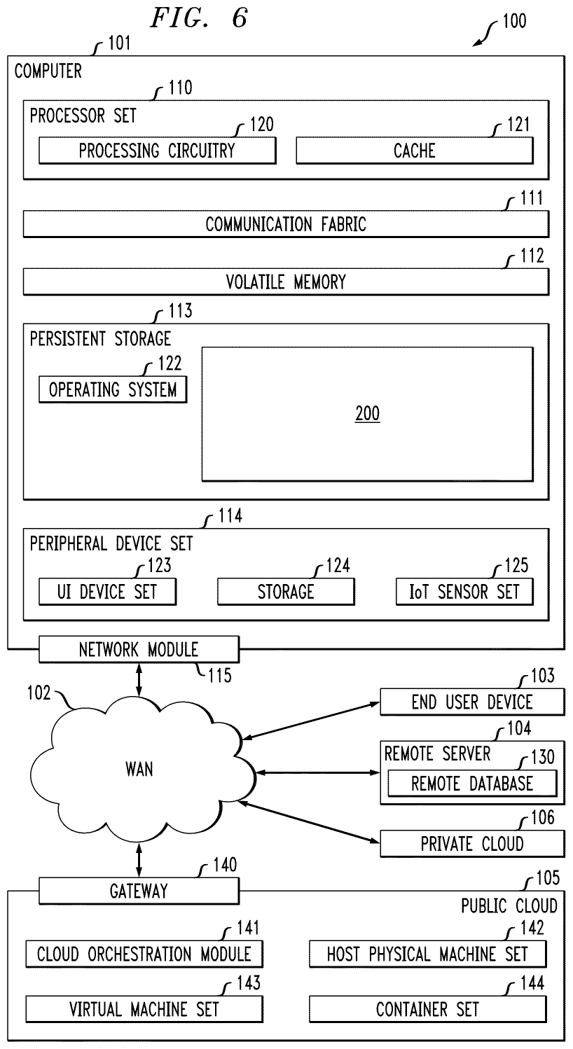

FIG. 5 is an example flowchart for an example method 500 for storing and reusing calibration data, in accordance with an example embodiment. In one example embodiment, qubit readout data (also referred to as qubit readout herein) for a plurality of device qubits on a given quantum computer is calibrated using deterministic bit patterns to generate calibration data (operation 504). The calibration data is stored in a database for use in one or more quantum processing tasks on the given quantum computer (operation 508). A given algorithm is run on the given quantum computer to generate qubit readout data (operation 512). A readout mitigation is performed to generate revised qubit readout data based on the qubit readout data, the performance of the readout mitigation including issuing, to a calibration routine, a set of labels identifying qubits used in the running of the given algorithm and obtaining, from the calibration routine, correction information based on the stored calibration data, wherein the readout mitigation is performed using the correction information (operation 516).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as quantum processor calibration system 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
calibrating qubit readout for a plurality of device qubits on a given quantum computer using deterministic bit patterns to generate calibration data;
running a given algorithm on the given quantum computer to generate qubit readout data;
performing a readout mitigation to generate revised qubit readout data based on the qubit readout data, the performance of the readout mitigation including issuing, to a calibration routine, a set of labels identifying qubits used in the running of the given algorithm; and
obtaining, from the calibration routine, correction information based on the calibration data, wherein the readout mitigation is performed using the correction information.

2. The method of claim 1, wherein the readout mitigation comprises a sampling readout mitigation, wherein the correction information comprises a set of matrices and wherein the performing of the readout mitigation further comprises using the set of matrices to solve an algebraic system of equations.

3. The method of claim 1, wherein the readout mitigation comprises an expectation value readout mitigation, wherein the correction information comprises a renormalization factor and wherein the performing of the readout mitigation further comprises using the renormalization factor to generate the revised qubit readout data.

4. The method of claim 1, wherein the calibration routine generates the correction information based on the set of labels identifying qubits used in running the given algorithm and an identification of a sampling type of readout mitigation, the correction information comprising a set of matrices generated by marginalizing a data distribution based on the calibration data.

5. The method of claim 4, further comprising renormalizing the marginalized data distribution.

6. The method of claim 1, wherein the calibration routine generates the correction information based on the set of labels identifying qubits used in running the given algorithm and an identification of an expectation value type of readout mitigation, the correction information comprising renormalization factor generated by computing expectation values on the qubits identified by the set of labels using Pauli Z observables and the calibration data.

7. The method of claim 1, wherein the type of readout mitigation performed is based on the use case and wherein the type of readout mitigation performed is an expectation value readout mitigation for variational algorithms.

8. The method of claim 1, wherein the type of readout mitigation performed is based on the use case and wherein the type of readout mitigation performed is a sampling readout mitigation for sampling problems.

9. A computer program product, comprising:
one or more tangible computer-readable storage media and program instructions stored on at least one of the one or more tangible computer-readable storage media, the program instructions executable by a processor, the program instructions comprising:
calibrating qubit readout for a plurality of device qubits on a given quantum computer using deterministic bit patterns to generate calibration data;
running a given algorithm on the given quantum computer to generate qubit readout data;
performing a readout mitigation to generate revised qubit readout data based on the qubit readout data, the performance of the readout mitigation including issuing, to a calibration routine, a set of labels identifying qubits used in the running of the given algorithm and obtaining, from the calibration routine, correction information based on the calibration data, wherein the readout mitigation is performed using the correction information.

10. The computer program product of claim 9, wherein the readout mitigation comprises a sampling readout mitigation, wherein the correction information comprises a set of matrices and wherein the performing of the readout mitigation further comprises using the set of matrices to solve an algebraic system of equations.

11. A system comprising:
a memory; and
at least one processor, coupled to said memory, and operative to perform operations comprising:
calibrating qubit readout for a plurality of device qubits on a given quantum computer using deterministic bit patterns to generate calibration data;
running a given algorithm on the given quantum computer to generate qubit readout data;
performing a readout mitigation to generate revised qubit readout data based on the qubit readout data, the performance of the readout mitigation including issuing, to a calibration routine, a set of labels identifying qubits used in the running of the given algorithm and
obtaining, from the calibration routine, correction information based on the calibration data, wherein the readout mitigation is performed using the correction information.

12. The system of claim 11, the system further comprising an interface coupled to the at least one processor and configured to facilitate the running of the given algorithm on the given quantum computer.

13. The system of claim 12, the system further comprising the given quantum computer, coupled to the interface and configured to perform the running of the given algorithm.

14. The system of claim 11, wherein the readout mitigation comprises a sampling readout mitigation, wherein the correction information comprises a set of matrices and wherein the performing of the readout mitigation further comprises using the set of matrices to solve an algebraic system of equations.

15. The system of claim 11, wherein the readout mitigation comprises an expectation value readout mitigation, wherein the correction information comprises a renormalization factor and wherein the performing of the readout mitigation further comprises using the renormalization factor to generate the revised qubit readout data.

16. The system of claim 11, wherein the calibration routine generates the correction information based on the set of labels identifying qubits used in running the given algorithm and an identification of a sampling type of readout mitigation, the correction information comprising a set of matrices generated by marginalizing a data distribution based on the calibration data.

17. The system of claim 16, the operations further comprising renormalizing the marginalized data distribution.

18. The system of claim 11, wherein the calibration routine generates the correction information based on the set of labels identifying qubits used in running the given algorithm and an identification of an expectation value type of readout mitigation, the correction information comprising renormalization factor generated by computing expectation values on the qubits identified by the set of labels using Pauli Z observables and the calibration data.

19. The system of claim 11, wherein the type of readout mitigation performed is based on the use case and wherein the type of readout mitigation performed is an expectation value readout mitigation for variational algorithms.

20. The system of claim 11, wherein the type of readout mitigation performed is based on the use case and wherein the type of readout mitigation performed is a sampling readout mitigation for sampling problems.
